(19) United States
(12) Patent Application Publication
(10) Pub. No.: US 2023/0414976 A1
(43) Pub. Date: Dec. 28, 2023

(54) METHOD AND APPARATUS FOR MAINTAINING AIRFLOW IN A POWERED AIR PURIFYING RESPIRATOR

(71) Applicant: 3M INNOVATIVE PROPERTIES COMPANY, St. Paul, MN (US)

(72) Inventors: Douglas D. Jensen, Woodbury, MN (US); Kenneth J. Krepel, Plymouth, MN (US); James F. Poch, New Richmond, WI (US); Dale M. Bissen, Woodbury, MN (US); Michael L. Parham, Marine on St. Croix, MN (US); Paul A. Martinson, Maplewood, MN (US)

(21) Appl. No.: 18/252,971

(22) PCT Filed: Nov. 10, 2021
(86) PCT No.: PCT/IB2021/060420

§ 371 Date: May 15, 2023

Related U.S. Application Data
(60) Provisional application No. 63/198,832, filed on Nov. 16, 2020.

(51) Int. Cl. A62B 18/04; A62B 18/08

(52) U.S. Cl. CPC A62B 18/045; A62B 18/08

(57) ABSTRACT

A blower/filtration unit for a powered air purifying respirator (PAPR) includes a motor configured to operate according to a motor control algorithm. The blower/filtration unit also includes a first pressure sensor positioned at an inlet of the blower/filtration unit. The blower/filtration unit also includes a second pressure sensor positioned at an outlet of the blower/filtration unit. The blower/filtration unit also includes a motor controller that executes the motor control algorithm. The motor control algorithm determines a motor speed required to maintain an airflow rate based on signals from the first and second pressure sensors.

### BACKGROUND

Powered air-purifying respirators (PAPRs) are fan-forced positive pressure respirators used to provide a user of the PAPR with filtered air. PAPRs generally comprise a mask, blower unit, and a power source. A variety of masks may be employed including hoods, partial face masks and others as known to those of skill in the art. The blower unit includes a motor-driven fan for drawing in ambient air. The ambient air is filtered through one or more filters designed to remove any specific contaminant. The filtered air is delivered to the face mask for the user to breath in.

PAPRs are used in a variety of environments that contain airborne contaminants that may be harmful to humans such as, for example, particulates and/or organic gases and vapors. The use of PAPRs is widespread throughout a large variety of environments including, for example, general industry, healthcare, mining, and smelting.

### SUMMARY

A blower/filtration unit for a powered air purifying respirator (PAPR) includes a motor configured to operate according to a motor control algorithm. The blower/filtration unit also includes a first pressure sensor positioned at an inlet of the blower/filtration unit. The blower/filtration unit also includes a second pressure sensor positioned at an outlet of the blower/filtration unit. The blower/filtration unit also includes a motor controller that executes the motor control algorithm. The motor control algorithm determines a motor speed required to maintain an airflow rate based on signals from the first and second pressure sensors.

### BRIEF DESCRIPTION OF THE DRAWINGS

FIG. 1 is a perspective view of a typical PAPR shown being worn by a user.

FIG. 2 is a perspective and diagrammatic view of a typical PAPR.

FIG. 3 is a perspective view of an embodiment of a blower/filtration unit for a PAPR.

FIG. 4 is a control schematic of the system of FIG. 3 according to an embodiment of the invention.

FIG. 5 illustrates a PAPR with built-in pressure sensors in accordance with embodiments herein.

FIG. 6 illustrates a pressure sensing flow control schematic in accordance with embodiments herein.

FIG. 7 illustrates a calibration curve determination in accordance with embodiments herein.

FIG. 8 illustrates a PAPR that may be used in embodiments herein.

FIG. 9 illustrates a method of maintaining compliant airflow in a PAPR in accordance with embodiments herein.

FIG. 10 illustrates an industrial environment in which embodiments herein may be particularly useful.

### DETAILED DESCRIPTION

As used in this description, the following terms have the meanings as indicated: “User” is a person who interacts with the PAPR either by wearing and/or making any adjustment to the PAPR.

“Ambient magnetic field strength (ambient MF)” means any magnetic field strength that is below a magnetic field strength that interferes with the function of mechanical and/or electronic equipment. Such magnetic field strength may be the measured strength of an actual magnetic field in an environment or an estimated magnetic field strength value (based on known effects of magnetic fields on mechanical and/or electronic equipment).

“High magnetic field (HMF) strength” means any magnetic field strength at which the function of mechanical and/or electronic equipment may be impaired due to the influence of the magnetic field.

“Threshold magnetic field” (threshold MF) is a magnetic field strength that defines the boundary between an ambient magnetic field strength and a high magnetic field strength as those terms are used herein.

“Compliant air flow” is a volumetric air flow that is compliant with any and all pertinent regulations related to air flow in respirators.

Powered air-purifying respirators generate airflow to the breathing space of a user by means of a fan that draws in air. The air is directed through one or more filters before it is delivered to the user. The volume of air delivered to the user is a important consideration, with minimal volumetric quantities required to support adequate respiration and comfort of the user. Regulatory bodies promulgate various regulations related to PAPRs and typically mandate minimal airflow requirements. Currently, in the United States, NIOSH 42 CFR Part 84 requires loose fitting PAPRs to produce a minimum volumetric air flow of 170 liters per minute (L/min).

Certain factors can affect air flow in a PAPR. For example, as the filter(s) collect contaminants the ease with which air can flow through the filter will be diminished. Thus, higher fan speeds will be required to maintain airflow as filters become loaded or clogged with contaminants. Some PAPRs employ electronics to maintain factory-calibrated airflow at nominal values.

Brushless DC motors offer significant advantages for use in PAPR designs, as they provide efficiency with comfort in a lighter, longer lasting design. However, brushless DC motors experience operational issues when in a high magnetic field environment because of the magnetic circuit inside the motor. Additionally, depending on the operations being conducted in a high magnetic field area, there may be low, medium, or high particulate presence. The presence of a high magnetic field does not necessarily correlate to a particulate presence or level in an area. So even if air flow can be maintained at a constant rate, the actual air flow provided to a wearer of a PAPR may fall below a compliance requirement based on particulate loading in a filter.

PAPRs that use sensored brushless DC motors will often stop entirely in the presence of a high magnetic field. This is due to the hall effect sensors used to provide commutation signals become overdriven by the high magnetic field. High magnetic field environments are typically present in a smelting facility where large currents are used to liquefy aluminum or other metals.

PAPRs that use sensorless brushless DC motor control have a different problem in HMFs in that they will continue to run, but the fan speed slows down considerably. Possibly even below an airflow that is required for respiratory protection, which is an unacceptable outcome.

One potential solution is to fix the motor speed at constant RPM. However, if there is significant particulate loading on the filter—and as a result the filter pressure drop increases—then locking the motor speed in the HMF will not maintain air flow. Air flow decreases from increasing pressure drop due to filter loading. At some point the system flow will drop below that needed to maintain claimed or regulatory required respiratory protection.

Historically, it has been difficult to directly measure airflow in a PAPR as sensors have been too expensive to directly incorporate into the PAPR itself, both from a cost and a power consumption concern. However, as measurement quality of direct pressure sensors increases and costs decrease, the ability to provide a PAPR with direct pressure sensing becomes available.

Environmental conditions have also been shown to potentially have a detrimental effect on PAPR performance. One example of a challenging environment is the use of a PAPR in a high magnetic field environments, such as, for example, in the potrooms employed in the smelting process. It has been observed that PAPR airflow rates slow or even stop when the magnetic field strength reaches certain levels due to the adverse effects of the high magnetic field on the function of the motor. Magnetic fields can disrupt a variety of motors that are typically employed in PAPRs. For example, typical brushless DC motors are susceptible to disruption through interference with hall effect sensors. Likewise, sensorless brushless DC motors can have compromised performance due to the interaction of the external magnetic field with the internal field of the motor. Brushed motors may be employed with use of magnetic shielding; however, this approach is not desirable because of the limited lifetime of brushed motors. Magnetic fields may also affect PAPR performance by exerting effects on other components of the motor/blower. For example, impellors made of conductive material may be susceptible to disruption via formation of eddy currents. U.S. Provisional Patent Application with Ser. No. 63/114,100, filed on Nov. 16, 2020, discusses potential motor control solutions for maintaining air flow in such areas.

High magnetic fields are one of many examples that may cause a traditional motor control mode to malfunction. For example, damage to the PAPR or to a component (e.g. from a drop or fall) may cause the system to deviate from a calibration curve. Additionally, other triggering events may also cause the PAPR to provide lower, or higher, air-flow than necessary. One previous solution was to provide an airflow indicator as a check against the calibration curve.

Incorporating one or more pressure sensors into the PAPR itself provides broader air flow control solutions, improved PAPR and filter design opportunities, and overall increased safety for workers. In some embodiments, pressure-drop based systems and methods described herein are used as the default control mode for the PAPR. In other embodiments, pressure-drop based systems and methods are only used when a triggering event, such as detection of a high magnetic field, detection of potential damage, or another event indicating that a pressure-drop control mode may be more reliable, or that a diagnostic check is needed to verify functionality of PAPR components.

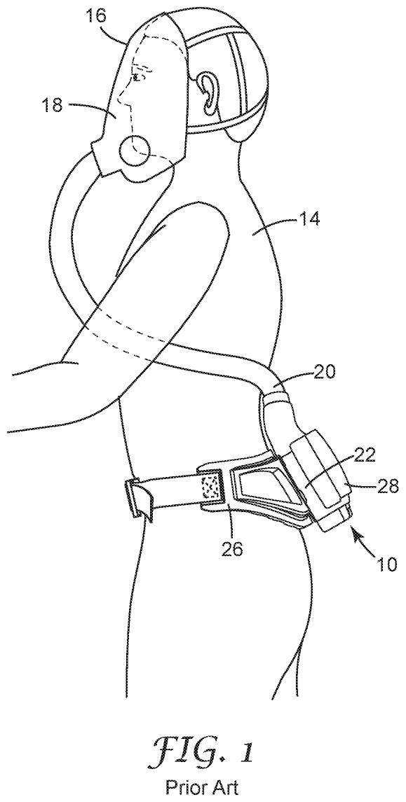

FIG. 1 depicts a typical prior art PAPR 10 being worn by a user 14. PAPR 10 comprises breathing head gear 16 shown disposed on the face of the user 14 creating a breathing space 18 in which filtered air is supplied through a breathing tube 20 for the user to inspire and into which the user can exhale. Breathing head gear 16 may be a breathing mask, hood, helmet, hard-top, or other suitable component having an inlet for filtered air defining a breathing space 18 for the user. PAPR 10 includes a blower/filter unit 22 that is typically attached to the user 14 via a belt 26 secured about the waist of the user 14. Blower/filter unit 22 is designed to be worn by a user in an atmosphere having unwanted respiratory (and potentially other) contaminants.

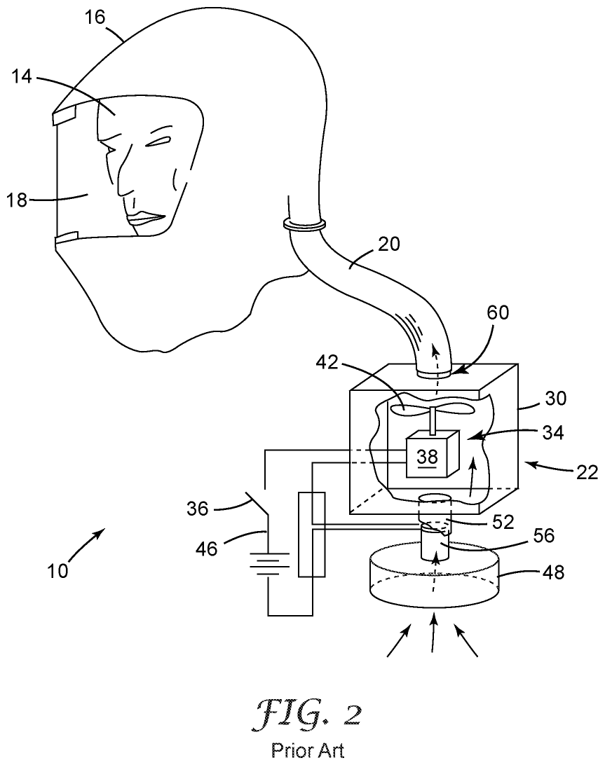

A more detailed view of a typical blower/filter unit 22 is shown in FIG. 2. Blower/filter unit 22 includes a blower housing unit 30 that houses a blower 34. Blower 34 comprises a motor 38 and an impellor 42. Motor 38 is driven by a power source 46 that is typically a battery pack attached to the user (not shown). Blower/filter unit 22 also includes one or more replaceable filter cartridges, canisters, or other filter units 48, a housing fluid (air) inlet 52, and a filter-fluid (air) outlet 56. Blower 34 is used to create negative pressure in a chamber of the blower housing unit 30, which draws air from the ambient environment through one more filter cartridge(s) 48 for removing contaminants from the ambient air prior to delivering it via the breathing tube 20 to the breathing space 18 for the user 14 to inhale. The path of air flow is depicted with arrows in FIG. 2.

Blower housing unit 30 may further include electronics and other components directed to maintaining factory-calibrated air flow. Such components include flow control algorithms and motor modulators to control the speed of the motor (not shown).

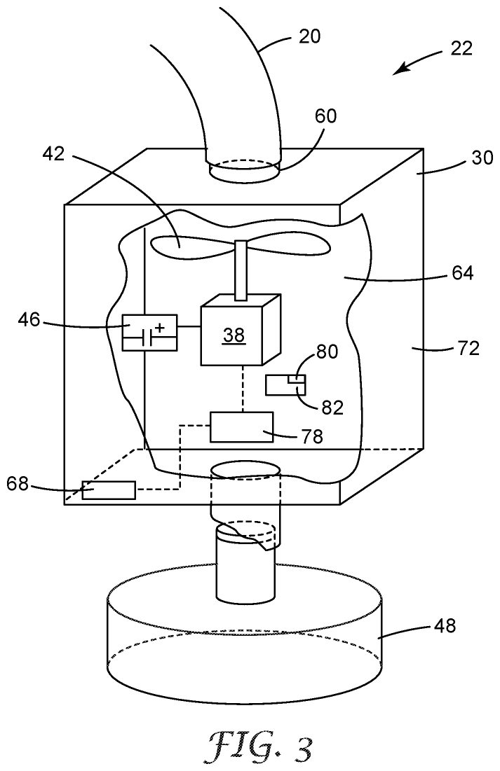

FIG. 3 depicts an embodiment of a blower/filter unit 22. Blower/filter unit 22 includes a blower housing unit 30 that contains a motor 38. In one embodiment with 30 as the blower housing, a sensor could be located inside of housing unit 30 near the inlet and another near the outlet and a third (for ambient sensing) on the outside of housing unit 30. Motor may be a brushed motor or brushless motor. In the instance of a brushless motor, motor 38 may be sensored (hall effect sensors) or sensorless. In one embodiment, the motor 38 comprises a brushless direct current (DC) motor (BLDC). Motor 38 drives an impellor 42, which creates negative pressure within a cavity 64 of the blower/filter unit 22 to pull air from the ambient environment through one or more filter cartridges 48. Filtered air is then driven through a breathing tube 20, having a positive pressure relative to the ambient environment, that is fluidly coupled to the blower/filter unit 22 via a housing fluid (air) outlet 60. Filtered air is then delivered to the breathing space of the breathing head gear (not shown). Detecting an actual rate of flow through filter cartridge(s) 48 would be helpful in ensuring that adequate airflow is provided to a user of the PAPR.

As described above, blower/filter unit 22 may include a magnetic field sensor (MF sensor) 68 for detecting magnetic field strength. MF sensor 68 may be provided within the blower housing unit 30 or in another suitable location where it is able to detect the magnetic field strength of the environment in which the user is located. Any MF sensor suitable for detecting magnetic field strength may be employed.

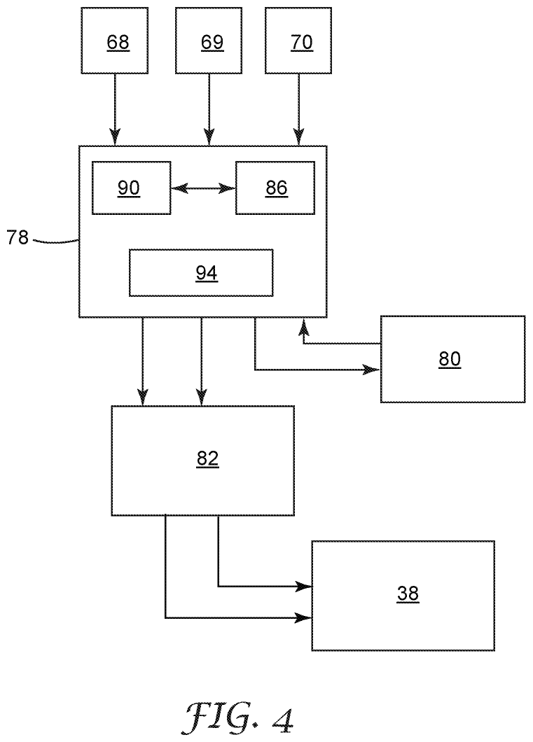

Different sensors, such as magnetic field sensor 68, pressure sensors 69 or other sensors 70 are operatively coupled to an electronic process controller 78, (detailed in FIG. 4) which may comprise various circuitry, memory, software, and the like. Electronic process controller 78 may comprise functions for controlling air flow (air flow control function) to the breathing space of the breathing head gear (not shown in FIG. 3) based on incoming sensor readings.

For example, in some embodiments, electronic process controller 78 comprises air flow control circuitry (not shown) for executing, based on a detected pressure drop across the blower, a control function that may adjust motor speed to maintain compliant air flow through the PAPR. The adjustment may be based on a detected pressure drop indicative of actual loading occurring on a filter.

The control function controls motor speed according to predetermined calibration parameters, in which motor speed may fluctuate dependent upon certain signals received by the electronic process controller. Such calibrated flow functions are known to those of skill in the art. Electronic process controller 78 operates responsive, to input by MF sensor 68, pressure sensor(s) 69 and/or other sensors 70, which may include altitude, humidity or other sensors. For example, electronic process controller 78, in a pressure drop control mode as described below in greater detail, may operate solely based on a detected pressure drop across the blower unit. Electronic process controller 78 determines a motor speed, and executes the speed based on received sensor input. In an embodiment, such air flow control circuitry may operate by employing a motor controller 82. Motor controller 82 is thus operatively coupled to electronic process controller 78. In an embodiment, electronic process controller 78 is configured to send input to motor controller 82 and also to receive input from motor controller 82. Motor controller 82 is configured to send a motor speed signal to the electronic process controller, which is configured to receive, and in some embodiments, to store such input data. Motor controller 82 may include a motor speed sensor 80. Motor speed sensor may be contained within motor controller (as shown in FIG. 3). Alternatively, motor speed sensor 80 may be independent of motor controller 82 in which case it would be operatively coupled to the electronic process controller 78 either directly or through the motor controller 82. Other signals may also be generated and sent by the motor controller 82.

Electronic process controller 78 is configured to send a motor voltage signal to the motor controller, which is configured to receive such a signal. Motor controller 82 is responsive to motor voltage signals generated by the electronic process controller 78 and modulates the motor speed in accordance with such signals. Electronic process controller 78 may generate and send other signals to the motor controller 82.

Motor controller 82 is operatively coupled to motor 38, which is configured to receive and respond to input signals from motor controller 82. Such signals may include motor voltage signals to control the speed of the motor. Motor 38 may be capable of receiving and responding to various other input signals as well.

FIG. 4 is a control schematic of an embodiment of the PAPR 10 of the present invention. In one embodiment, an electronic process controller 78 is operatively coupled to a motor 38 via a motor controller 82. Motor controller 82 includes a function that controls the speed of the motor 38 and hence the volume of air delivered to the breathing space 18 (not shown). The speed of the motor is determined by the electronic process controller 78 according to computations made by electronic process controller 78, which, in turn, are based on inputs received from MF sensor 68, pressure sensor(s) 69, and other sensors 70, such as temperature, humidity, altitude, etc. Inputs from sensors 68-70 are compared to a reference threshold magnetic field that is stored within memory 86 by a comparator 90. Electronic process controller 78 selects an appropriate air flow (motor speed) control function 94 based on result of the comparison made by the comparator 90 and sends signals appropriate to control motor speed (for example voltage signals) to the motor 38. As will be detailed below, certain air flow functions are based on readings made by motor speed sensor 80 that are sent to and stored by electronic process controller 78.

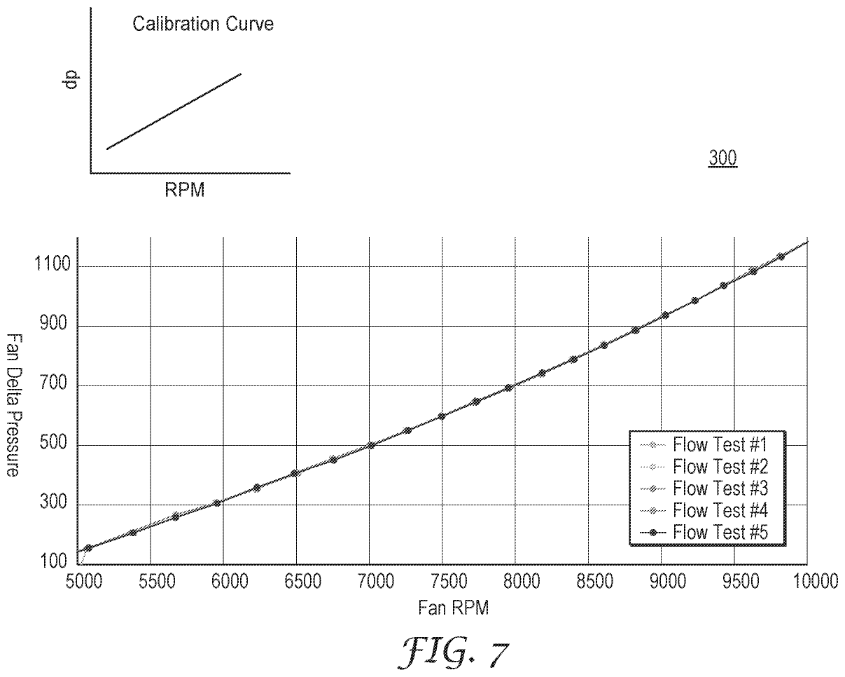

A flow control function can be executed in response to a variety of stimuli. For example, one of the pressure-drop-based control functions described herein may be triggered when a high magnetic field is detected and traditional motor control functions are not accessible. However, in some embodiments, it is expressly contemplated that pressure-drop-based control functions described herein are used to control the function of the motor any time the blower is in operation. Additionally, in some embodiments, a pressure-drop control function may be initiated based on detected damage, or based on a manual or automatically initiated check of device health. For example, if the PAPR is in an area with a low (or substantially no) magnetic field, it is possible to run the PAPR using a control mode based on a calibration curve (as illustrated in FIG. 7 below) while also receiving pressure drop information from incorporated pressure sensors. Running both control mode options simultaneously may provide feedback about motor health and performance.

Embodiments herein provide for a blower system that includes pressure sensors that can capture pressure information, which can then be used to determine air flow through a PAPR filtering system.

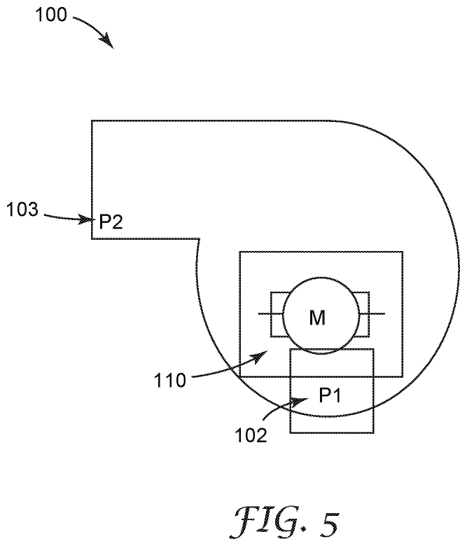

FIG. 5 illustrates a blower system for a PAPR with built-in pressure sensors in accordance with embodiments herein. Existing art in fan theory shows the relationship between fan RPM and generated pressure can infer the resulting flow of the fan without sensors specifically used to measure flow. FIG. 5 illustrates a blower system 100 with a motor 110 and pressure sensors 102 and 103. Sensor 102 is positioned where air enters the fan, and sensor 103 is positioned where air exits the fan, a position arrangement that allows sensors 102, 103 to detect the pressure of air entering the fan and exiting the fan provide the largest difference in pressure.

Pressure sensors 102, 103 can be used in combination to determine both ambient pressure and pressure generated across a fan. However, while a particular positional arrangement is illustrated in FIG. 5, it is expressly contemplated that one or multiple sensors could be located anywhere on or within a PAPR unit, provided communicable coupling with the air pressure of the region they wish to measure is created.

While pressure sensors 102, 103 are specifically called out in FIG. 5, it is expressly contemplated that additional sensors may also be present, either in a blower unit 100, elsewhere in a PAPR, or in communication with PAPR. For example, an internal temperature sensor may be integrated into a helmet portion to monitor body temperature, or elsewhere to measure ambient temperature. Temperature sensors may also be integrated into pressure sensors 102, 103 so that independent sensors are not needed. An accelerometer may also be present to detect movement/orientation of blower 100 (or of a headtop, visor, wearer or other associated feature), possibly detecting a drop or other damage-causing event to motor 110, to blower 100, or to a user generally. A humidity sensor may also be present. Location-based sensors may also be in communicable contact with a motor controller of motor 110, for example GPS or other position-based sensing, area beacons, etc. A microphone or acoustic pressure sensor may also be present to detect acoustic changes characteristic of fan/motor function, possibly detecting: fan/motor start up, shut down, and degradation due to motor wear or fan/motor damage. Damage may be due to drop, impact, or improper cleaning. A capacitance sensor may also be present to detect improper exposure to water.

Positioning of these sensors to detect the pressure of air entering the fan and exiting the fan provide the largest difference in ambient pressure measurement. Unlike differential sensors which measure the difference in pressure between two positions (and do not provide an ambient pressure), having sensors 102, 103 positioned at air entrance and exit points allows for measurement of absolute pressure at both locations. Thus, using only two sensors, three values of interest can be measured: ambient pressure (and temperature) at each of the entrance, exit, as well as the pressure developed across the fan. This pressure difference can be used in concert with the measured speed of the fan (in RPM, for example) to infer the actual flow being generated.

As discussed in greater detail below, by measuring and adjusting a motor speed and pressure signals from sensors 102, 103, the dependent variable of flow can be determined or maintained.

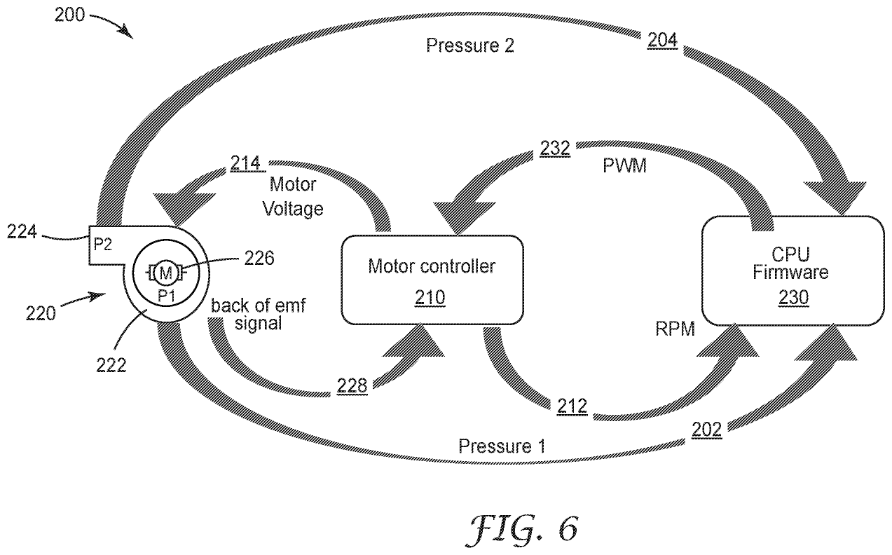

FIG. 6 illustrates a pressure sensing flow control schematic in accordance with embodiments herein. Schematic 200 illustrates operation of a motor controller 210 in a PAPR flow control system 200.

Upon initiation, a PAPR commences a start-up procedure which signals a motor to run at speeds sufficient to produce compliant air flow to a breathing space at least as high as those required by pertinent regulatory requirements, e.g., 170 L/min in accordance with current NIOSH regulations. Upon initiation, a PAPR may execute any factory-set flow control function to achieve compliant volumetric airflow. Regardless of the flow control that is run, it must reach and maintain a volumetric airflow that is at least equivalent to those required by pertinent regulations.

In embodiments where a magnetic field is expected, as described in greater detail in U.S. Provisional Patent Application with Ser. No. 63/114,100, filed on Nov. 16, 2020, a magnetic field sensor executes and measures the ambient field strength.

A control mode is selected for the PAPR. The control mode may default to a control mode based on a calibration curve stored in a memory in the device. Or a pressure-drop control mode may be the default mode, as described in greater detail below. In some embodiments, the control mode switches from a calibration-based control mode to a pressure-based control mode in response to a trigger, such as a detected high magnetic field or potential damage to the PAPR. A pressure-drop based control scheme may also be triggered by a sudden impact to maintain airflow until the wearer can complete their worktask and have the unit inspected.

In some embodiments, after a specific time interval (start-up delay interval), the schematic illustrated in FIG. 6 takes over. Motor controller 210 sends a motor voltage 214 to motor 226 of blower 220. Blower unit 220 communicates a magnetic field strength signal 228 back to motor controller 210. blower unit 220 also communicates an inlet pressure sensor 202 and an outlet pressure sensor 204 to firmware 230. Firmware receives a motor speed signal 212 from motor controller 210 and, based on the pressure signals 202, 204 and the motor speed signal 212, firmware determines a control algorithm 232 that is communicated to, and executed by, motor controller 210.

In some embodiments, the time interval ranges for sensors, including sensors 222, 224, magnetic field sensors, temperature sensors, etc. can be as short as 10 ms or as long as 30 seconds, or at any interval sufficient to maintain the level of control required for the airflow control procedure. In some embodiments, the time interval is about 10 ms. During airflow control procedure, PAPR may be, in effect, continuously receiving sensor signals and, based on the sensor signals, adjusting a control signal or switching between control modes accordingly.

As described with respect to FIG. 3, electronic process controller 78 includes circuitry, software, functionality, and/or the like to control airflow control. In one embodiment, electronic process controller comprises at least two air control functions: a calibrated flow function and a pressure-drop based flow function such as those described herein. As depicted in FIG. 6, a PAPR continuously executes the airflow control procedure to select an appropriate air flow control function based on sensor signals indicative of the environment.

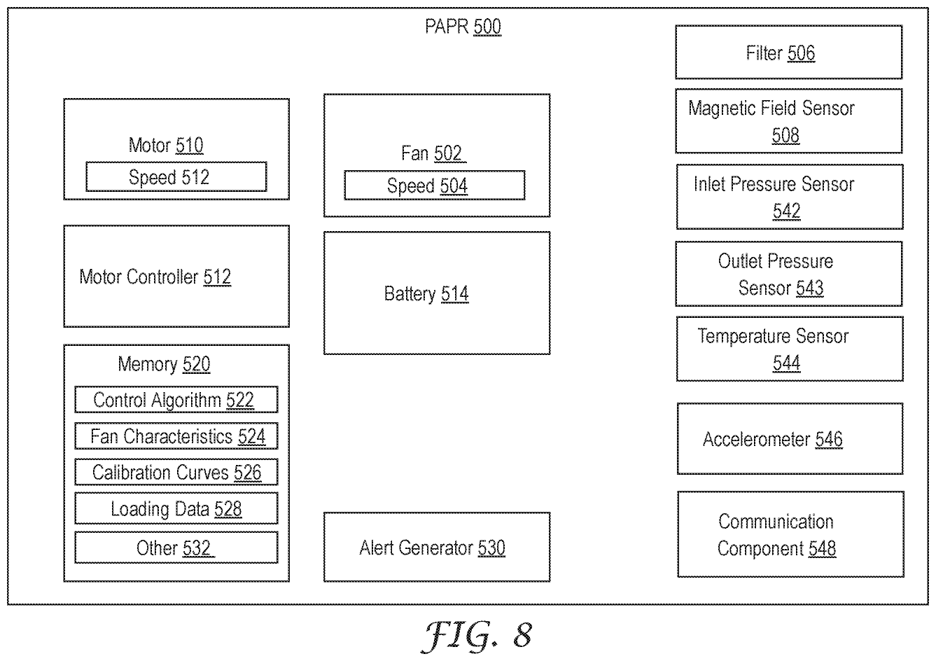

FIG. 6 envisions that a blower system 220, motor controller 210 and control algorithm 230 are all housed in one PAPR unit. However, it is expressly contemplated that control algorithm(s) 230 are housed in a device remote from motor controller 210. For example, as discussed in greater detail in FIGS. 8-10, in some embodiments a PAPR may communicate with a hub, other PAPRs, or other devices to obtain information pertinent to operation of blower unit 220.

FIG. 7 illustrates a calibration curve determination in accordance with embodiments herein. When depending on known fan laws where pressure vs RPM equates to flow, fluid performance of a fan is dictated solely by the mechanical geometry of the fan, and not dependent on anything except the mechanical design and not dependent on things such as voltage, current, bearing type, etc. For non-varying mechanical constructions, the fluidic performance of such a device is substantially the same from unit to unit. Thus, one design calibration can be performed to determine one performance curve expected for all fans made from the same parts. If this indeed can be shown, considerable time can be saved during manufacturing by avoiding the need to individually calibrate each fan to establish a unique calibration of pressure/RPM/flow.

Calibration of a fan requires operating one or more fans at specific temperatures and pressures. By varying the RPM and measuring the flow through and ambient pressure difference across the fan, a family of points are created in the form of a calibration curve. The resulting curve can be fitted to first, second, third or higher order polynomials depending on the desired flow control accuracy. It is found that fitting curves to a third order polynomial provides results suitable for use in respirators where multiple speeds are desired.

This concept is not limited to controlling flow, and may find usefulness in other types of operation. For example, a fan may be allowed to run in a constant voltage mode where filter loading will influence flow; the flow being reduced as the filter loads. Use of the ambient pressure difference and RPM can be used to determine if the flow being generated is inside or outside a desired flow range, and, if outside a range, generate a flow alarm.

Additionally, in embodiments where a high magnetic field is not present, a combination of voltage/RPM control and pressure-differential control could be used to determine information about the motor/impellor, such as bearing fatigue or other state of health factors. This may allow for advanced warning to the PAPR user, or to the PAPR service personnel thereby indicating the need for the PAPR to be serviced and repaired before being used again.

Further, a combination of flow control and flow alarming can be done simultaneously. Take for example a kinked breathing tube or over-loaded filter. In these cases, the system will attempt to control at the desired flow but an alarm or other action is taken when the ambient pressure difference and RPM indicate such flow cannot be obtained.

FIG. 7 demonstrates a characteristic fan curve can be generated for a given pressure and temperature condition. However, it is expressly contemplated that other corrections can be made to flow measurements. Calculating a volumetric flow requires knowing air density, which can be calculated based on ambient pressure and temperature. Humidity may also be a consideration in some embodiments. Ambient pressure sensing is required for air density correction as PAPRs are used at widely varying altitudes and air pressure variation is the largest contributor to air density variation. Ambient temperature is the next largest factor in air density.

FIG. 7 illustrates one calibration curve generated for at one ambient pressure and temperature. Operation at different temperatures and pressures produces a different calibration curve for each of these other conditions. This results in a family of curves representing the entire operating range of the fan across different air densities, based on different ambient pressures and different ambient temperatures.

By making multiple measurements of flow and pressure differences at different ambient pressures and temperatures, adjustments to the polynomial fit of the fan characteristic curve based on ambient pressure and or ambient temperature discussed herein can be done to correct the volumetric flow for air density conditions. These corrections only need to be measured and calculated once for incorporation across fans of the same geometry, and are then consistent from unit to unit.

In combination with the positional arrangement of sensors 222, 224, which provide continuous sampling of air pressure at their location, the actual air pressure useful for calculation of air density can also be measured.

The values reported are affected by operation of the fan however. In a PAPR with a filter on the inlet of the fan, the inlet sensor is providing the ambient pressure minus the pressure drop through the filter while the outlet sensor is providing the ambient air pressure plus the pressure which the apparatus used to distribute the air to the user. In such a system the actual ambient pressure is only known when the fan is stopped, since only then is the air pressure at either sensor unaffected by air flow through the fan or by downstream impedance of the outlet air distribution components. During operation of the fan, the precise air pressure and thus air density is not known, other than it is above the inlet pressure and below the outlet pressure. However, in most systems the less variant pressure is the outlet pressure since the inlet pressure will vary as the filter loads with contaminates. In such embodiments, the outlet pressure is used as the ambient pressure.

In other embodiments, the ambient pressure is retrieved by the controller from a remote pressure sensor. Remote may include a pressure sensor located elsewhere on a user, for example on another tool or PPE associated with the user. Alternatively, the ambient pressure may come from a pressure sensor located in the environment, for example within an acceptable distance of the user, or in an area experiencing similar environmental conditions.

FIG. 8 illustrates a PAPR that may be used in embodiments herein. PAPR 500 may include additional functionality or components not shown in FIG. 8. PAPR 500 includes a filter 506 which may experience particulate loading during operation of PAPR 500.

PAPR 500 includes a fan 502 which operates at a speed 504, driven by motor 510. Motor 510 is controlled by motor controller 512. PAPR 500 is powered by a battery 514. PAPR 500 also includes a memory 520 which, among other things, may store a control algorithm 522 that adjusts a motor speed 504 based on readings from a magnetic field sensor 508, a pressure sensor 542 at a fan inlet, a pressure sensor 543 at a fan outlet, and/or a temperature sensor 544. Memory 520 may also store characteristics 524 related to operation of fan 502. Memory 520 may also store loading data 528 for one or more areas of an environment. Loading data 528 may be historic or contemporarily received data. Loading data 528 may be stored in memory 520, as illustrated in FIG. 8, or may be retrievable from a remote storage, in other embodiments.

PAPR 500 may also include one or more sensors for receiving ambient environmental information, for example a pressure sensor 542, which may be positioned at a fan inlet, as well as a pressure sensor 543, located at a fan outlet, which may be used to more accurately select a calibration curve 526 based on correcting for a known temperature, air density, humidity or altitude, for example. PAPR 500 may also have an accelerometer 546 in some embodiments, which may be useful for detecting if or when PAPR 500, or components thereof, may have been damaged.

PAPR 500 may also have a microphone or acoustic pressure sensor in some embodiments, which may be useful for validating that PAPR 500 starts and stops or may have been damaged or worn. In some embodiments this sensor may be used to either indicate the unit should be removed from service or indicate that a service step should be conducted within a set interval. PAPR 500 may also have a capacitance sensor in some embodiments, which may be useful for determining if sensitive components may have been improperly exposed to water and indicate that the PAPR should be removed from service.

PAPR 500 may also have a communication component 548 which may receive signals from an external source, such as a central hub, another PAPR unit, or another source. For example, instead of having an inlet pressure sensor 542 built in, PAPR 500 may receive an ambient pressure reading from an external source, either a sensor in the environment, which may send ambient environmental information signals, such as ambient temperature, pressure, humidity, density, or other relevant information. Such signals may be received directly by communication component 548, or may be sent to a central hub or control system which provides it to communication component 548 periodically or in response to a request.

PAPR 500 may also have an alert generator 530 that provides a visual, textual, audio or haptic feedback to a wearer when a motor speed 512 reaches maximum available speed. Alert generator 530 may also generate an alert provided to communication component 548 which may broadcast the alert to nearby workers, to a central hub, to a safety officer, or to another source which may be able to ensure that a wearer of PAPR 500 leaves an area.

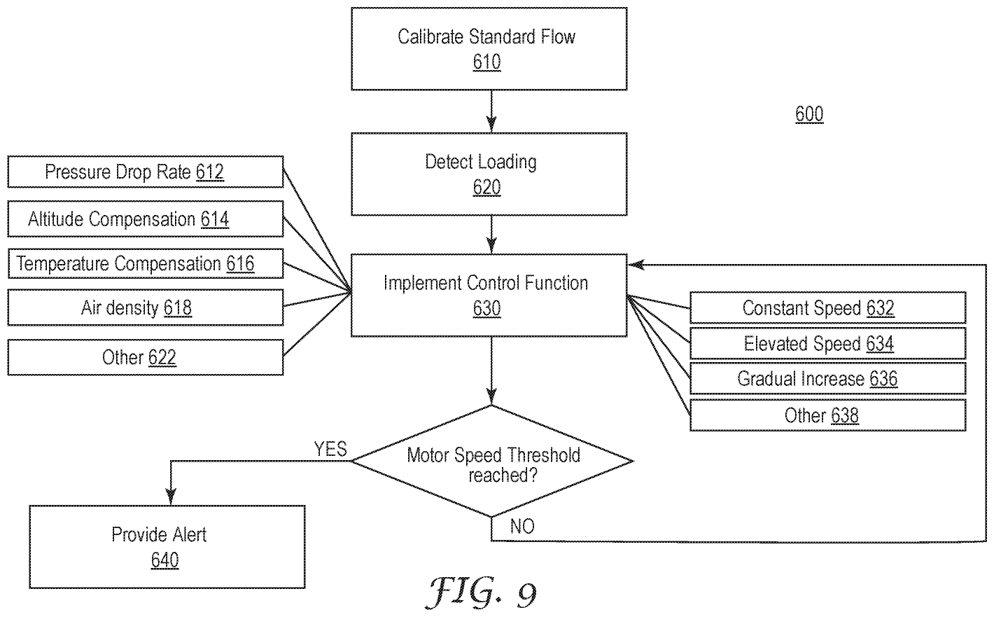

FIG. 9 illustrates a method of maintaining compliant airflow in a PAPR in accordance with embodiments herein. FIG. 9 illustrates a method of maintaining compliant airflow in a PAPR in accordance with embodiments herein. Method 600 may be useful for PAPRs in areas with magnetic field that can interfere with normal blower operations.

In block 610, a standard calibration mode is in operation in a PAPR. The standard calibration mode of operation is based on a current particulate loading of a filter.

In block 620, a loading rate is detected. For example, an updated loading rate may be detected periodically by receiving an updated pressure signal indicating an inlet pressure of a blower and an outlet pressure, for example from pressure sensors located at a blower inlet and outlet. The pressure sensors may be absolute pressure sensors, in some embodiments, able to provide both an ambient pressure signal as well as, in combination, a pressure drop measurement across the blower.

In block 630, the motor control function is selected based on inputs from sensors, and from algorithmic decisions based on current and prior states of the control function. The motor control function may be implemented by a motor controller, and may set a motor speed based on a received pressure drop rate 612, obtained from signals from a blower inlet and outlet. The motor speed may be selected to maintain a compliant air flow rate in a PAPR. The motor control function may correct the calculated speed to compensate for a known altitude 614, an air temperature 616, an air density 618, or another correction factor 622.

Implementing a control function may include locking a speed of the motor at a constant rate, as indicated in block 632, in some embodiments. In other embodiments, implementing a control function includes locking a speed of the motor at an elevated rate, as indicated in block 634. In other embodiments, implementing a control function includes gradually increasing a motor speed, as indicated in block 636. In other embodiments, as indicated in block 638 implementing a control function includes increasing a motor speed at another control functions are also contemplated.

The motor control function may be implemented based on known loading based on a pressure drop, as indicated in block 612. The pressure drop may be determined based on pressure sensors internal to a blower unit. Alternatively, the ambient pressure signal may be provided to a motor controller. For example, PAPRs may be able to communicate with each other, with a hub, and/or with beacons or other measurement tools that can provide ambient environmental conditions.

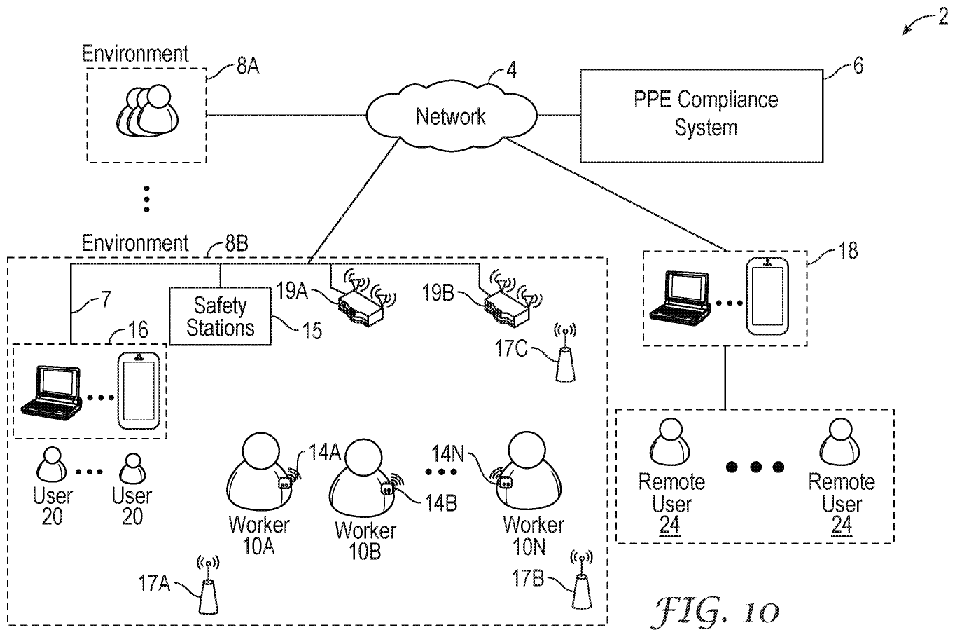

In block 640, an alert is provided if an operational constraint of the PAPR is met. For example, a battery of the PAPR may be low, or a motor speed may have increased to a maximum speed and may, therefore, no longer be able to provide sufficient airflow. Alerts may be provided for other operational concerns. FIG. 10 illustrates an industrial environment in which embodiments herein may be particularly useful. FIG. 10 illustrates a worksite in which embodiments of the present invention may be useful. FIG. 10 is a block diagram illustrating an example network environment 702 for a worksite 708A or 708B. The worksite environments 708A and 708B may have one or more workers 710A-710N, each of which may need to interact with equipment or environments that require the use of a PAPR. Workers 710A-710N may wear a PAPR with a filter that experiences particulate loading. Some areas in environments 708A or 708B may include a high magnetic field that interferes with an ability of a PAPR to accurately detect loading, requiring other methods of maintaining compliant airflow. PAPRs worn by workers 710A-710N may have pressure sensors, as described herein, that are positioned at an inlet and outlet of a blower, and able to provide absolute fan inlet and outlet pressures as well as a pressure drop across the fan.

Environment 708B includes a communication system 706 which may facilitate communication between PAPRs in environment 708A or 708B. Such communication could include a pressure sensor calibration/confirmation between blowers. This could be done in a controlled environment outside the work zone during startup when all PAPRs are at the same elevation and not impacted by effects of motor speed, filters, breathing tubes, etc. For example, if any blowers do not agree within a tolerance of the rest, an alarm could be raised.

Communication system 706 may receive communication from one PAPR, for example concerning particulate loading in a given HMF area, an ambient pressure, ambient temperature, a location of the PAPR, or an alert about a nearby worker. Central system 706 may also allow safety professionals to review data about particulate loading in different areas of an environment 708A or 708B, conditions in environments 708A-708B, workers in 708A-708B, or about device health conditions of a given PAPR. Central system 706 may include a database that stores data received from connected PAPRs and/or other PPE about workers, environments 708A and 708B, including particulate loading in different areas, for example.

In general, central system 706, as described in greater detail herein, is configured to receive information from and about environments 708A and 708B, workers 710A-710N, and PPE devices. System 706 may be connected, through network 704, to one or more devices or displays 716 within an environment, or devices or displays 718, remote from an environment. System 706 may provide alerts to workers 710A-710N based on device operating conditions, environmental conditions, or other unsafe or harmful scenarios. System 706 may also be integrated into alarm systems throughout environments 708A, 708B. System 706 may be able to communicate with PAPRs worn by workers in environments 708A, 708B and may be able to track movements of PAPRs. Knowledge of where a PAPR is within environments 708A, 708B may allow for known ambient conditions to be provided to motor controller for calculating a more accurate motor control algorithm.

As shown in the example of FIG. 9, system 702 represents a computing environment in which a computing device within of a plurality of physical environments 708A, 708B (collectively, environments 708) electronically communicate with central system 706 via one or more computer networks 704.

In some examples, each of environments 708 include computing facilities, such as displays 716, or through associated PPEs, by which workers 710 can communicate with PPE compliance system 706. For examples, environments 708 may be configured with wireless technology, such as 802.11 wireless networks, 802.15 ZigBee networks, and the like. In the example of FIG. 13, environment 708B includes a local network 707 that provides a packet-based transport medium for communicating with PPE computing system 706 via network 704. In addition, environment 708B includes a plurality of wireless access points 719A, 719B that may be geographically distributed throughout the environment to provide support for wireless communications throughout the work environment.

As shown in the example of FIG. 10, an environment, such as environment 708B, may also include one or more wireless-enabled beacons, such as beacons 717A-717C, that provide accurate location information within the work environment. For example, beacons 717A-717C may be GPS-enabled such that a controller within the respective beacon may be able to precisely determine the position of the respective beacon. Alternatively, beacons 717A-717C may include a pre-programmed identifier that is associated in central system 706 with a particular location. Based on wireless communications with one or more of beacons 717, or data hub 714 worn by a worker 710 is configured to determine the location of the worker within work environment 708B. In this way, event data, such as particulate loading data captured at a given time, for example, is reported to central system 706 may be stamped with positional information.

In example implementations, an environment, such as environment 708B, may also include one or more safety stations 715 distributed throughout the environment to provide viewing stations for accessing central system 706. Safety stations 715 may allow one of workers 710 to check out articles of PPE and/or other safety equipment, verify that safety equipment is appropriate for a particular one of environments 708, and/or exchange data. For example, safety stations 715 may transmit alert rules, software updates, or firmware updates to articles of PPE or other equipment.

Safety stations 715 may also provide information about a given PAPR used in an environment 708.

In addition, each of environments 708 include computing facilities that provide an operating environment for end-user computing devices 716 for interacting with central system 706 via network 704. For example, each of environments 708 typically includes one or more safety managers or supervisors, represented by users 720 or remote users 724, who are responsible for overseeing safety compliance within the environment. In general, each user 720 or 724 interacts with computing devices 716, 718 to access central system 706. For example, the end-user computing devices 716, 718 may be laptops, desktop computers, mobile devices such as tablets or so-called smart cellular phones.

Users 720, 724 interact with central system 706 to control and actively manage many aspects of safely equipment utilized by workers 710, such as accessing and viewing usage records, analytics and reporting. For example, users 720, 724 may review compliance information received and stored by system 706. In addition, users 720, 724 may interact with system 706 to review device health information. For example, system 706 may receive information from a temperature sensor regarding device temperature trends, including whether PAPR gets too hot or cold over time. An accelerometer in a PAPR may also indicate whether the device has been dropped, which may indicate that a maintenance check should be performed early. Additionally, information about device events could help predict malfunctions. For example, a blower or fan may degrade or wear over time. Impact data, for example collected from an accelerometer, may help identify rough or inappropriate handling. An accelerometer may also be able to measure vibrations in bearings which may help predict failure. Additionally, an accelerometer could be used in conjunction with voltage/rpm/filter loading vs pressure-differential control trends. A microphone could also be used with either a voltage/rpm control mode or with a pressure differential control mode.

A battery run down rate may also be inferable by data received from PAPRs over time. PAPR batteries may be able to have a measured internal resistance or may be able to detect and report a change in voltage over time. A central hub may be able to receive information periodically about remaining battery life in a PAPR and may be able to predict early failure accordingly.

Particulate loading rates may also be collectable, and analyzed over time and used to better predict future loading trends in different areas. For example, each time a PAPR leaves an HMF area, actual loading information may be obtained and communicated to central system 706. Additionally, such information may be helpful for designing better filters in the future. Additionally, special filters may be usable to determine initial safety risks, for example a filter may have an embedded sensor to assess the loading in different areas of an environment. In some embodiments, a PAPR either has a location identifier, such as GPS or another location identifier, or can be located using beacons in the environments 708. Such a filter loading rate could be communicated to the cloud to inform users of how much relative particulate is present in certain work locations.

PAPRs may also provide information about a user, for example body heat trends captured overtime, which may indicate heat-related injury or exhaustion, or over-breathing trends which may indicate a negative pressure or a tight-fitting respirator. Additionally, as noted in U.S. Provisional Patent Application with Ser. No. 63/072,442, filed on Aug. 31, 2020, incorporated herein by reference, additional health-related tracking may be done based on sensor feedback.

The positioning of pressure sensors at a blower unit inlet and outlet provides a control algorithm an improved ability to maintain constant and consistent airflow by manipulating the motor speed based a measured pressure change indicative of actual loading.

Advantageously, embodiments discussed herein provide ways to measure actual loading of a filter in a PAPR while the PAPR is in operation by taking in-situ pressure measurements at an inlet and an outlet of a blower fan unit. Using the ambient pressure at both positions and the pressure drop across the filter, actual loading can be monitored.

This opens up a lot of options for design improvement of PAPR filters, PAPR housings, and overall improve functions of PAPR devices. Additionally, function of the PAPR itself may also be improved. As compared to systems described in U.S. Provisional Patent Application with Ser. No. 63/114,100, filed on Nov. 16, 2020, which calculates expected particulate loading, systems and methods herein can determine actual loading of a PAPR filter and adjust a motor speed in-situ to provide a wearer with the longest safe time in a high loading area before a motor speed reaches a maximum speed and compliant airflow can no longer be provided.

Embodiments and systems herein are described with respect to a single PAPR unit for the ease of understanding. However, it is expressly contemplated that multiple PAPRs may operate in accordance with embodiments herein, and their performance may be monitored by, and sensor signals uploaded to a cloud-based system which may also for improved performance of PAPRs and filters.

It is also expressly contemplated that the pressure differential/flow rate control systems herein may, in addition to adjusting to environmental changes (e.g. temp/humidity; heat stress, etc.) may also provide the basis for improved safety rules for environmental conditions that are likely or expected to occur. For example, hazard areas also have automatic triggers to increase or decrease flow rates, such as ambient temperatures and humidity that may make it likely that a user will overheat that may trigger a safety rule: for example, when a PAPR user. enters such a hazard area, a flow rate automatically increases in anticipation.

Further, it is expressly contemplated that a motor controller may receive other ambient data that can be used to adjust a motor control algorithm to improve both comfort and battery life. Currently, motor control algorithms focus on breath response of a user and experienced filter loading. However, it may be advantageous to preemptively adjust PAPR settings before a user's discomfort is detectable with breath sounds, and/or to improve battery life in the process.

Additionally, it is expressly contemplated that additional information may be reported out by a PAPR unit, either to other nearby workers, to a supervisor, to a hub, or to a cloud-based storage center. Such information may be reported directly by a PAPR, through a different PPE with a communication component, or through a central control unit. For example, pressure calibration results and alarms may be reported. Additionally, filter loading rates reported throughout an environment may be useful for creating a particular loading density map for an area. The state of health of a blower or other PAPR components may be reported to determine whether blowers are being used equally strenuously. Additionally, positional information of PAPRs may be reported to monitor worker progress or detect worker injury or problems.

However, it is expressly contemplated that PAPRs described herein are designed to operate autonomously.

As will be appreciated other capabilities may be added to the PAPRs of embodiments herein without departing from the scope of the present disclosure. For example, additional programming, e.g. hysteresis functions may be included. Likewise, PAPRs described herein may include additional components such as air quality monitors. PAPR may also include user interface(s) and/or display screens to display any or all of the parameters already discussed.

Further, using the measured pressure differential, many characteristic curves can be generated, for example flow data, motor speed, and input voltage may be read from a blower during operation. Several curves may be compared between blowers and an action level for allowed variance be used to indicate that a given blower has an abnormal condition and should be inspected/serviced. A blower/filtration unit for a powered air purifying respirator (PAPR) is presented that includes a motor configured to operate according to a motor control algorithm. The blower/filtration unit also includes a first pressure sensor positioned at an inlet of the blower/filtration unit. The blower/filtration unit also includes a second pressure sensor positioned at an outlet of the blower/filtration unit. The blower/filtration unit also includes a motor controller that executes the motor control algorithm. The motor control algorithm determines a motor speed required to maintain an airflow rate based on signals from the first and second pressure sensors.

The blower/filtration unit may be implemented such that the first and second pressure sensors are absolute pressure sensors.

The blower/filtration unit may be implemented such that it includes a temperature sensor.

The blower/filtration unit may be implemented such that the motor control algorithm corrects a calculated motor speed based on an air density compensation. The air density compensation is calculated in part based on a temperature sensor signal from the temperature sensor.

The blower/filtration unit may be implemented such that the motor control algorithm corrects a calculated motor speed based on an altitude compensation.

The blower/filtration unit may be implemented such that it includes a communication component capable of sending and receiving sensor signals to a second device.

The blower/filtration unit may be implemented such that it includes an accelerometer.

The blower/filtration unit may be implemented such that the communication component provides an indication of a potential drop to the second device.

The blower/filtration unit may be implemented such that the second device is a second blower/filtration unit of a second PAPR.

The blower/filtration unit may be implemented such that the second device provides a motor control value for a correction to the motor control function.

The blower/filtration unit may be implemented such that the motor control value is a location of the blower/filtration unit, an ambient temperature, an ambient pressure, or a humidity.

The blower/filtration unit may be implemented such that the motor control function maintains the speed of the motor at a motor speed necessary to provide compliant airflow to an air mask when the blower/filtration unit is coupled to the air mask.

The blower/filtration unit may be implemented such that it includes a motor speed detector and the controller further comprises a memory for storing motor speed data.

The blower/filtration unit may be implemented such that the motor speed detector detects the motor speed at a predetermined time interval to generate a reference motor speed that is stored by the controller to create a stored reference motor speed. The stored reference motor speed is replaced each time the motor speed is detected.

The blower/filtration unit may be implemented such that it includes a magnetic field sensor.

The blower/filtration unit may be implemented such that it includes a housing. The housing comprises an air outlet fluidly coupled to an air conduit, the air conduit fluidly coupled to an air mask.

The blower/filtration unit may be implemented such that the motor control algorithm corrects a calculated motor speed based on air density compensation. The air density compensation is calculated in part based on pressure measured by the first, second or other pressure sensors.

The blower/filtration unit may be implemented such that the communication component receives a signal from an ambient pressure sensor indicative of true ambient air pressure. The ambient pressure sensor is located outside of the blower/filtration unit.

The blower/filtration may be implemented such that it includes an accelerometer and wherein the memory also stores an indication of a detected fall.

The blower/filtration unit may be implemented such that it includes a positional sensor and wherein the memory stores an indication of a position of the PAPR.

The blower/filtration unit may be implemented such that it stores a detected particulate loading level associated with the position.

The blower/filtration unit may be implemented such that it stores an indication of a device health.

A method of maintaining airflow in a powered air-purifying respirator (PAPR) that includes providing a PAPR comprising a motor, and a controller. The method also includes receiving an ambient pressure, an inlet pressure of a blower unit of the PAPR, and an outlet pressure of the blower unit; calculating a motor speed necessary to generate a compliant air flow rate based on the ambient pressure, the inlet pressure and the outlet pressure; and implementing the motor speed, using the controller.

The method may be implemented such that the ambient pressure, inlet pressure and outlet pressure are periodically received. The calculated motor speed is also recalculated periodically. The controller implements each new calculated motor speed once calculated.

The method may be implemented such that the inlet pressure is received from an inlet pressure sensor located at an inlet of the blower unit.

The method may be implemented such that the inlet pressure sensor is an absolute pressure sensor.

The method may be implemented such that the outlet pressure is received from an outlet pressure sensor located downstream of a filter unit.

The measure may be implemented such that the outlet pressure sensor is an absolute pressure sensor.

The method may be implemented such that it includes storing the calculated motor speed.

The method may be implemented such that it includes communicating the calculated motor speed to a second device.

The method may be implemented such that the second device is a server.

The method may be implemented such that it includes comparing the calculated motor speed to a maximum motor speed and, if the calculated motor speed exceeds the maximum motor speed, providing an alert.

The method may be implemented such that the ambient pressure is received from a second device.

The method may be implemented such that periodically comprises a time interval ranges between about continuously to about 30 seconds.

The method may be implemented such that the motor control function maintains airflow at a compliant flow rate.

The method may be implemented such that it includes correcting the calculated motor speed based on a received indication of an ambient condition. The ambient condition is an ambient temperature, an ambient humidity, an altitude of the PAPR, an air density, or a location of the PAPR.

The method may be implemented such that the indication is received from a second device.

The method may be implemented such that the second device is a central hub that received the indication from a sensor in the environment.

A controller for a powered air-purifying respirator (PAPR) is presented that includes a sensor signal receiver that receives an indication of a pressure drop across a filter unit of the PAPR and an ambient pressure indication. The controller also includes a motor speed algorithm that based on the received pressure drop and ambient pressure, calculates a motor speed necessary to maintain a compliant airflow through the PAPR. The motor speed algorithm changes a speed of a motor of the PAPR to the calculated motor speed.

The controller may be implemented such that the indication of the pressure drop is calculated from an upstream pressure sensor and a downstream pressure sensor. The upstream pressure sensor is upstream of the filter unit and the downstream pressure sensor is downstream from the filter unit.

The controller may be implemented such that one of the upstream and downstream pressure sensors is an absolute pressure sensor.

The controller may be implemented such that one of the upstream and downstream pressure sensors provides the ambient pressure indication.

The controller may be implemented such that the sensor signal receiver receives the pressure drop indication and the ambient pressure indication periodically. The motor speed algorithm updates the calculated motor speed based on the periodically received indication. The motor speed algorithm changes the motor speed accordingly.

The controller may be implemented such that the sensor signal receiver is integrated into the PAPR.

The controller may be implemented such that the sensor signal receiver is integrated into the controller.

The controller may be implemented such that one of the pressure drop indication and the ambient pressure indications are received from a second device.

The controller may be implemented such that the second device is remote from the PAPR.

The controller may be implemented such that it includes receiving a correction indication. The motor speed algorithm calculates a correction factor for the calculated speed based on the correction indication.

The controller may be implemented such that the correction indication is received from a second PAPR.

The controller may be implemented such that correction indication is received from a central system.

The controller may be implemented such that the correction indication is an ambient temperature, an ambient air density, an ambient humidity, or a location of the PAPR.

A system for maintaining airflow in a powered air-purifying respirator (PAPR) includes a central server and a PAPR. The PAPR includes a sensor signal retriever, a filter unit, a motor, and a controller that provides a motor speed algorithm to control a motor speed of the motor upon receiving, from the sensor signal retriever, a pressure drop associated with the filter unit and an ambient pressure and calculates a motor speed sufficient to maintain a compliant airflow through the PAPR and updates the motor speed to the calculated motor speed.

The system may be implemented such that controller calculates the motor speed based on a calibration curve.

The system may be implemented such that the pressure drop is calculated from an upstream pressure sensor and a downstream pressure sensor. The upstream pressure sensor is upstream of the filter unit and the downstream pressure sensor is downstream from the filter unit.

The system may be implemented such that one of the upstream and downstream pressure sensors is an absolute pressure sensor.

The system may be implemented such that one of the upstream and downstream pressure sensors provides the ambient pr4essure indication.

The system may be implemented such that the sensor signal receiver receives the pressure drop and the ambient pressure indication periodically. The motor speed algorithm updates the calculated motor speed based on the periodically received indication. The motor speed algorithm changes the motor speed accordingly.

The system may be implemented such that the sensor signal receiver is integrated into the PAPR.

The system may be implemented such that the sensor signal receiver is integrated into the controller.

The system may be implemented such that one of the pressure drop indication and the ambient pressure indications are received from a second device.

The system may be implemented such that the second device is remote from the PAPR.

The system may be implemented such that it includes receiving a correction indication, and wherein the motor speed algorithm calculates a correction factor for the calculated speed based on the correction indication.

The system may be implemented such that the correction indication is received from a second PAPR.

The system may be implemented such that correction indication is received from a central system.

The system may be implemented such that the correction indication is an ambient temperature, an ambient air density, an ambient humidity or a location of the PAPR.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A blower/filtration unit for a powered air purifying respirator (PAPR) comprising:
a motor configured to operate according to a motor control algorithm;
a first pressure sensor positioned at an inlet of the blower/filtration unit;
a second pressure sensor positioned at an outlet of the blower/filtration unit; and
a motor controller that executes the motor control algorithm, and wherein the motor control algorithm determines a motor speed required to maintain an airflow rate based on signals from the first and second pressure sensors.

2. (canceled)

3. The blower/filtration unit of claim 1, and further comprising a temperature sensor.

4. The blower/filtration unit of claim 3, wherein the motor control algorithm corrects a calculated motor speed based on an air density compensation, and wherein the air density compensation is calculated in part based on a temperature sensor signal from the temperature sensor.

5. (canceled)

6. The blower/filtration unit of claim 1, and further comprising a communication component capable of sending and receiving sensor signals to a second device.

7. (canceled)

8. The blower/filtration unit of claim 6, wherein the second device provides a motor control value for a correction to the motor control function.

9. The blower/filtration unit of claim 8, and wherein the motor control value is a location of the blower/filtration unit, an ambient temperature, an ambient pressure, or a humidity.

10. (canceled)

11. The blower/filtration unit of claim 1, further comprising a motor speed detector and the controller further comprises a memory for storing motor speed data.

12. The blower/filtration unit of claim 11, wherein the motor speed detector detects the motor speed at a predetermined time interval to generate a reference motor speed that is stored by the controller to create a stored reference motor speed, wherein the stored reference motor speed is replaced each time the motor speed is detected.

13. (canceled)

14. (canceled)

15. The blower/filtration unit of claim 1, wherein the motor control algorithm corrects a calculated motor speed based on air density compensation and wherein the air density compensation is calculated in part based on pressure measured by the first, second or other pressure sensors.

16. (canceled)

17. A method of maintaining airflow in a powered air-purifying respirator (PAPR) comprising:
providing a PAPR comprising a motor, and a controller;
receiving an ambient pressure, an inlet pressure of a blower unit of the PAPR, and an outlet pressure of the blower unit; calculating a motor speed necessary to generate a compliant air flow rate based on the ambient pressure, the inlet pressure and the outlet pressure; and implementing the motor speed, using the controller.

18. The method of claim 17, wherein the ambient pressure, inlet pressure and outlet pressure are periodically received, and wherein the calculated motor speed is also recalculated periodically, and wherein the controller implements each new calculated motor speed once calculated.

19. (canceled)

20. The method of claim 17, and further comprising:
comparing the calculated motor speed to a maximum motor speed and, if the calculated motor speed exceeds the maximum motor speed, providing an alert.

21. (canceled)

22. The method of claim 17, wherein periodically comprises a time interval ranges between about continuously to about 30 seconds.

23. (canceled)

24. The method of claim 17, and further comprising:
correcting the calculated motor speed based on a received indication of an ambient condition; and
wherein the ambient condition is an ambient temperature, an ambient humidity, an altitude of the PAPR, an air density, or a location of the PAPR.

25-31. (canceled)

32. A system for maintaining airflow in a powered air-purifying respirator (PAPR) comprising:
a central server;
a PAPR comprising:
a sensor signal retriever;
a filter unit;
a motor; and
a controller that provides a motor speed algorithm to control a motor speed of the motor upon receiving, from the sensor signal retriever, a pressure drop associated with the filter unit and an ambient pressure and calculates a motor speed sufficient to maintain a compliant airflow through the PAPR and updates the motor speed to the calculated motor speed.

33. The system of claim 32, wherein controller calculates the motor speed based on a calibration curve.

34. The system of claim 32, wherein the pressure drop is calculated from an upstream pressure sensor and a downstream pressure sensor, wherein the upstream pressure sensor is upstream of the filter unit and the downstream pressure sensor is downstream from the filter unit.

35. The system of claim 32, wherein the sensor signal receiver receives the pressure drop and the ambient pressure indication periodically, and wherein the motor speed algorithm updates the calculated motor speed based on the periodically received indication, and wherein the motor speed algorithm changes the motor speed accordingly.

36. (canceled)

37. (canceled)

38. The system of claim 32, and further comprising receiving a correction indication, and wherein the motor speed algorithm calculates a correction factor for the calculated speed based on the correction indication.

39. The system of claim 38, wherein the correction indication is an ambient temperature, an ambient air density, an ambient humidity or a location of the PAPR
